(19) United States
(12) Patent Application Publication
(10) Pub. No.: US 2022/0059857 A1
(43) Pub. Date: Feb. 24, 2022

(54) MEMBRANE FOR THE SELECTIVE TRANSPORT OF SUBSTANCES

(71) Applicant: Carl Freudenberg KG, Weinheim (DE)

(72) Inventors: Iain Smith, Dursley, Gloucestershire (GB); Michael Roth, Mainz (DE); Christian Waschinski, Heidelberg (DE); Sandra Villing-Falusi, Heddesheim (DE)

(21) Appl. No.: 17/312,400

(22) PCT Filed: Dec. 6, 2019
(86) PCT No.: PCT/EP2019/083949

§ 371 Date: Jun. 10, 2021

(30) Foreign Application Priority Data
Dec. 12, 2018 (DE) 10 2018 131 922.3

(51) Int. Cl. H01M 8/1053; H01M 8/1004; H01M 8/1023; H01M 8/1025; H01M 8/04119

(52) U.S. Cl. CPC H01M 8/1053; H01M 8/1004; H01M 8/04149; H01M 8/1025; H01M 8/1023

(57) ABSTRACT

A membrane for selective transport of substances includes: a porous substrate with a comb polymer. The comb polymer contains a polymer main chain and several lateral chains covalently bonded to the polymer main chain. At least one of the several lateral chains has at least one Lewis-acid and/or Lewis-base functionality.

### CROSS-REFERENCE TO PRIOR APPLICATIONS

This application is a U.S. National Phase application under 35 U.S.C. § 371 of International Application No. PCT/EP2019/083949, filed on Dec. 6, 2019, and claims benefit to German Patent Application No. DE 10 2018 131 922.3, filed on Dec. 12, 2018. The International Application was published in German on Jun. 18, 2020 as WO 2020/120306 under PCT Article 21(2).

### FIELD

The present invention relates to a membrane for the selective transport of substances, such as, for example, ion-selective membranes for energy converters—in particular, fuel cells and electrolyzers—water vapor-permeable membranes for functional textiles and humidification modules, separators for energy storage devices such as, in particular, capacitors, and primary and secondary batteries and/or filter media for gas and liquid filtration.

### BACKGROUND

The aim of a membrane for the selective transport of substances is to selectively separate substance mixtures. In this, a distinction is made between three types of transport during the transport of substances through the membrane. These are passive transport, carrier transport, and active transport. During passive transport, the substances are transported in the direction of the potential gradient. The transport speed of the substances to be separated is influenced, among other things, by their mobility in the membrane. In the case of carrier transport, an additional binding of the transported substance to a free carrier or to a carrier bonded to the membrane is effected. In the case of active transport, a chemical reaction also enables the transport of substances counter to the potential gradient.

In electrochemical energy converters, ion-selective membranes make it possible to electrically separate the respective electrochemical half-cells from one another. At the same time, they are to enable a high degree of ion conductivity, e.g., for protons in fuel cells, between the half-cells and at the same time ensure a gas separation between the two half-cells. In addition, the membrane shall have a high degree of mechanical strength and chemical stability. In electrochemical energy storage devices, the membrane does not have to ensure gas exclusion. For this purpose, due to the higher voltage and energy density in some battery cells, it is advantageous for the membrane to have a high degree of electrochemical stability. Therefore, the membrane essentially helps determine the service life and performance of electrochemical energy storage devices and converters.

Water vapor-permeable membranes are used for humidifying substances—in particular, gases—in humidification modules. In this, as a rule, the membranes shall selectively prevent gas leakage, but nevertheless enable water permeability. In functional textiles, the selectivity consists in the membrane being water-impermeable but water vapor-permeable. In some applications, e.g., when pressure equalization is desired, it is advantageous if the water or water vapor permeability in one direction is greater than in the other.

Filter media serve for the separation or purification of substances—generally, suspensions, dispersions, or aerosols. Particular fields of application are gas and liquid filtration. In many cases, it is desirable for the filter medium to enable a selective transport of substances.

A disadvantage of membranes known in practice is that their transport properties of substances are usually determined by the physical structure of the membranes. For example, in a battery separator, ion transport takes place via its pore structure. As a result, the ion conductivity correlates with the size of the through-pores, and thus with the air permeability. As a result, they do not allow any decoupling of the ion conductivity from the pore structure or the air permeability of the membrane. In order to ensure the required high degree of ion conductivity, known membranes as a rule have a porous, continuous pore structure or air permeability. Since, at least in batteries, the pore sizes required for ion transport are, as a rule, significantly greater in known membranes than the ion radii of the ions to be transported (for example, Li-cation in Li-ion, Li—S, or Li-metal batteries), no ion-selective transport of substances through the membrane can therefore take place. Moreover, in the case of a pore-induced transport mechanism, the undesired substance transfer of, for example, gases, electrode particles or degradation products, ionic compounds, and dendrites cannot be reliably prevented.

Water vapor-permeable membranes, such as, in particular, humidifiers for fuel cells, have as a rule only a low degree of water vapor transport, since they are to be as gas-tight as possible. Moreover, they do not permit directed water vapor transport. That is, the water vapor permeability through the membranes is independent of direction. This is disadvantageous, because a rewetting can thus be excluded only by further measures, such as, for example, the adjustment of a temperature or pressure difference.

Moreover, in the case of filter media, it is often desirable to adjust the transport properties of substances independently of their physical structure. Thus, the filtration properties are, as a rule, very strongly predetermined by the pore structure. As a result, the filtration is always associated with a pressure loss.

US 20180069220 A1 describes a composite separator for use in Li-ion batteries. The composite separator consists of a microporous polyolefin membrane, which is coated with a porous coating made of inorganic particles and an organic binding agent. In this, the particles and the binders are matched to one another in their surface energy, such that better adhesion of the coating to the PO membrane is achieved. Ion transport with this separator is essentially enabled by the pore structure of the separator, such that there is no decoupling of conductivity and air permeability or porosity.

US 20180198156 A1 describes a separator for use in Li-sulfur batteries, which is coated with polydopamine and a conductive material. The coating is intended to prevent polysulfide shuttle, among other things, by means of the polydopamine. Here as well, there is no decoupling of ion conductivity and pore structure, due to the ion transport caused by the pore structure. In addition, the polydopamine of lithium can be reduced, which equates with a self-discharge of the battery.

US 20180040868 A1 describes a separator consisting of a porous substrate with a porous coating for use in Li-ion batteries. In order to increase the adhesion of the porous coating to the porous substrate, an emulsion binder layer is applied between the porous substrate and the porous coating. The ion transport with this separator is essentially defined by the pore structure of the separator, such that there is likewise no decoupling of the ion conductivity from the air permeability or porosity.

US 20180062142 A1 describes a separator for use in Li-sulfur batteries, which is coated with a functional layer. The functional layer consists of at least 2 carbon nanotube layers and at least 2 graphene oxide layers, which contain manganese dioxide particles. This functional layer is intended to increase the service life of the battery according to the invention. Ion transport with this separator is essentially made possible by the pore structure of the separator, such that there is likewise no decoupling of conductivity and air permeability or porosity.

U.S. Pat. No. 9,876,211 describes a multilayer battery separator for use in lithium-sulfur batteries, and its use in lithium-sulfur batteries to prevent sulfur shuttle. The first layer consists of an ion-conducting linear polymer, the second layer of inorganic particles with an organic binder, and, optionally, a third layer can consist of a porous substrate. Ion transport with this separator is essentially enabled by the pore structure of the separator, such that there is no decoupling of conductivity and air permeability or porosity.

U.S. Pat. No. 9,358,507 B2 describes a composite membrane formed by laminating a layer of moisture-permeable resin onto a surface of a hydrophobic porous membrane, wherein the layer of moisture-permeable resin is contained in a reinforcing porous membrane. The composite membrane is used as a water vapor separating membrane.

### SUMMARY

In an embodiment, the present invention provides a membrane for selective transport of substances, comprising: a porous substrate with a comb polymer, wherein the comb polymer contains a polymer main chain and several lateral chains covalently bonded to the polymer main chain, wherein at least one of the several lateral chains has at least one Lewis-acid and/or Lewis-base functionality.

### DETAILED DESCRIPTION

In an embodiment, the present invention provides a membrane for the selective transport of substances, which at least partially eliminates the aforementioned disadvantages. In particular, it is intended to provide a high degree of ion conductivity when used in electrochemical energy storage devices and converters. Furthermore, the ion conductivity is to be decoupled from the air permeability, and thus from the pore structure of the membrane.

Furthermore, it is intended to offer the possibility of preventing an undesired transfer of substances—for example, of dendrites and dissolved and/or particulate substances. In addition, the membrane is intended to have a low degree of ion resistance even in the case of air impermeability, in order to provide efficient energy storage devices and converters. When used as a water vapor-permeable membrane, such as, in particular, as a humidifier membrane for fuel cells, the membrane is to have a high level of water vapor transport with the highest possible gas-tightness. In addition, it is intended to enable a directed transport of water vapor.

When used as a filter medium, the membrane is intended to make it possible to adjust the transport properties of substances independently of their physical structure.

This aim is achieved by a membrane for the selective transport of substances, wherein the membrane contains a porous substrate with a comb polymer, wherein the comb polymer contains a polymer main chain and several lateral chains covalently bonded to the polymer main chain and wherein at least one of the lateral chains has at least one Lewis-acid and/or Lewis-base functionality.

According to the invention, it has been found that the aforementioned membrane makes it possible to decouple the ion conductivity of the membrane from its air permeability, and thus from its pore structure. Without being fixed upon a mechanism, it is assumed that this—e.g., when used in batteries, accumulators, capacitors, electrolyzers, and/or fuel cells—becomes possible in that, when interacting with the electrolyte, the Lewis-acid and/or Lewis-base functionalities can generate an ion-conductive path. This mechanism thus enables a porosity- and pore size-independent transport of the charge carriers through the membrane.

In addition, in the transport mechanism enabled by the membrane, the undesired transport of substances can be prevented. Thus, by decoupling ion conduction and pore size, it is possible by means of a targeted reduction of the pore size to prevent or at least reduce the passage of particles (for example, electrode particles or degradation products) and dendrites. In addition, the Lewis-acid and/or Lewis-base functionalities enable a selective transport of substances, as a result of which undesired ions can be prevented from passing through the membrane.

In practical tests, it has also been found that the membrane according to the invention combines a high degree of ion conductivity with a high degree of mechanical stability. In addition, the membrane according to the invention can be produced in one layer and nevertheless meet all requirements imposed on it. This is advantageous in terms of production and costs.

When used as a water vapor-permeable membrane, it was found that the membrane has a high level of water vapor transport with, simultaneously, a high degree of gas-tightness. Furthermore, it enables a directed transport of water vapor. It is assumed that such properties are enabled by generating a moisture-transporting pathway upon interaction of water vapor with the Lewis-acid and/or Lewis-base functionalities. This mechanism therefore enables the moisture to be transported through the membrane with simultaneous gas-tightness.

According to the invention, it has been found that the aforementioned membrane makes it possible to decouple the water vapor permeability of the membrane from its air permeability, and thus from its pore structure. Without being fixed upon a mechanism, it is assumed that this is possible—for example, when used in functional textiles and/or humidification modules—by the Lewis-acid and/or Lewis-base functionalities being able to generate a water transport path upon interaction with water or water vapor. This mechanism therefore enables the water and/or water vapor to be transported through the membrane in a porosity- and pore size-independent manner.

When used as a filter medium, the membrane enables the transport properties of substances to be adjusted independently of their physical structure.

The membrane according to the invention for the selective transport of substances is outstandingly suitable as a separator for energy converters—in particular, fuel cells and electrolyzers—energy storage devices such as, in particular, capacitors and primary and secondary batteries, and/or combinations thereof.

Preferred batteries are lithium-ion batteries, lithium-sulfur batteries, nickel-metal hydride batteries, nickel-cadmium batteries, nickel-iron batteries, nickel-zinc batteries, alkali-manganese batteries, lead-acid batteries, magnesium-ion batteries, sodium-ion batteries, zinc-air batteries, and lithium-air batteries.

Furthermore, redox-flow batteries—in particular, vanadium-redox flow batteries, vanadium-bromine-redox flow batteries, iron-chromium-redox flow batteries, zinc-bromine-redox flow batteries, and organic-redox-flow batteries—are preferred.

Furthermore, capacitors—in particular, supercapacitors, double-layer capacitors, hybrid capacitors, and pseudo-capacitors—are preferred.

Furthermore, fuel cells—in particular, LT polymer electrolyte fuel cells, HT polymer electrolyte fuel cells, alkaline fuel cells, direct methanol fuel cells, phosphoric acid fuel cells, and reversible fuel cells—are preferred.

Furthermore, the use of the membrane according to the invention as a water vapor-permeable membrane—in particular, for functional textiles and humidification modules, such as, for example, in humidifier modules for fuel cells—is preferred.

Furthermore, the use of the membrane according to the invention as a filter and/or filter medium for gas and liquid filtration is preferred.

According to the invention, the membrane has a porous substrate with a comb polymer.

Thereby, the comb polymer has a main polymer chain and several lateral chains covalently bonded to the main polymer chain, wherein at least one of the lateral chains has at least one Lewis-acid and/or Lewis-base functionality.

The advantage of using a comb polymer in comparison with linear polymers is that it has a lower tendency towards crystallization. As a result, the comb polymers as a rule exhibit lower densities and thereby a high lateral-chain mobility. The high lateral-chain mobility in turn leads to the ion conductivity being favored.

Another advantage of using a comb polymer is that it is possible to modify the chemical structure of the polymer backbone and the lateral chains independently of one another.

The term, “several lateral chains,” is to be understood according to the invention as meaning that at least two repeat units of the main chain have at least one of the lateral chains according to the invention. The comb polymer preferably has 10 to 3,000, more preferably 50 to 2,000, and more preferably 100 to 2,000, of the lateral chains according to the invention. Preferably at least 10%, e.g., 10% to 100%, preferably 20% to 100%, more preferably 50% to 100%, and in particular 75% to 100%, of the repeat units of the main chain have at least one, and preferably one to two, of the lateral chains according to the invention.

The term, “main polymer chain,” is understood according to the invention to mean the longest covalently-bonded chain of atoms of a polymer. The main polymer chain preferably has a molecular weight of at least 580 g/mol, e.g., from 580 g/mol to 50,000 g/mol, preferably from 1,000 g/mol to 20,000 g/mol, and more preferably from 1,500 g/mol to 10,000 g/mol, and/or at least 8, e.g., 8 to 2,000, preferably 25 to 1,000, and in particular 25 to 500, repeat units.

In a preferred embodiment of the invention, the main polymer chain has on average at least 3, e.g., 3 to 2,000, preferably 10 to 1,000, more preferably 50 to 500, and in particular 50 to 250, lateral chains. Thereby, different main chains may have different numbers of lateral chains.

Preferably, the polymer main chain has polymerized monomers, wherein the monomers are selected from the group consisting of acrylates, methacrylates, acrylic acids, methacrylic acids, acrylamides, methacrylamides, vinylamides, vinylpyridines, N-vinylimidazoles, N-vinyl-2-methylimidazoles, vinyl halides, styrenes, 2-methylstyrenes, 4-methylstyrenes, 2-(n-butyl)styrenes, 4-(n-butyl)styrenes, 4-(n-decyl)styrenes, N,N-diallylamines, N,N-diallyl-N-alkylamines, vinyl- and allyl-substituted nitrogen heterocycles, vinyl ethers, vinylsulfonic acids, allylsulfonic acids, vinylphosphonic acids, styrene sulfonic acids, acrylonitriles and methacrylnitriles, and/or mixtures thereof.

Particularly preferred polymerized monomers for the main polymer chain are acrylic acids, methacrylic acids, acrylates, methacrylates, vinylsulfonic acids, vinylphosphonic acids, styrene sulfonic acids, styrene, and/or mixtures thereof.

The term, “lateral chain,” is understood according to the invention to mean a polymer chain and/or oligomer chain which is covalently bonded to the main polymer chain and the chain length of which is shorter than that of the main polymer chain. The lateral chain preferably has a molecular weight of at least 220 g/mol, preferably from 220 g/mol to 5,000 g/mol, preferably from 220 g/mol to 4,500 g/mol, preferably from 360 g/mol to 4,000 g/mol, more preferably from 450 g/mol to 2,500 g/mol, more preferably from 600 g/mol to 2,500 g/mol, and in particular 700 g/mol to 2,500 g/mol, and/or at least 5, e.g., 5 to 250, preferably 8 to 100, and in particular 8 to 50, repeat units.

Preferably, the polymer lateral chain has polymerized monomers, wherein the monomers are selected from the group consisting of acrylates, methacrylates, acrylamides, methacrylamides, vinylamides, vinylpyridines, N-vinylimidazoles, N-vinyl-2-methylimidazoles, vinyl halides, styrenes, 2-methylstyrenes, 4-methylstyrenes, 2-(n-butyl)styrenes, 4-(n-butyl)styrenes, 4-(n-decyl)styrenes, N,N-diallylamines, N,N-diallyl-N-alkylamines, vinyl- and allyl-substituted nitrogen heterocycles, vinyl ethers, acrylonitriles and methacrylnitriles, acrylic acids, methacrylic acids, vinylsulfonic acids, allylsulfonic acids, vinylphosphonic acids, styrene sulfonic acids, and/or mixtures thereof.

Particularly preferred polymerized monomers for the polymer lateral chain are acrylic acids, methacrylic acids, acrylates, methacrylates, vinylsulfonic acids, vinylphosphonic acids, styrene sulfonic acids, and/or mixtures thereof.

In a preferred embodiment, the lateral chain is formed from polymerized macromonomers. By the term, “formed,” it is meant that the lateral chain is at least 95 wt %, and preferably up to 100 wt %, of the macromonomer. The term, “macromonomer,” is understood to mean oligomers or polymers which contain at least one polymerizable group. Macromonomers preferably have a molecular weight of at least 140 g/mol, e.g., from 140 g/mol to 10,000 g/mol, preferably from 220 g/mol to 5,000 g/mol, preferably from 360 g/mol to 2,000 g/mol, more preferably from 360 g/mol to 1,500 g/mol, more preferably 450 g/mol to 1,500 g/mol, and in particular 600 g/mol to 1,500 g/mol.

In this embodiment, in which at least one lateral chain is formed from polymerized macromonomers, the comb polymer preferably also has further monomers, e.g., acrylic acids, methacrylic acids, acrylates, methacrylates, vinylsulfonic acids, vinylphosphonic acids, styrene sulfonic acids, and/or mixtures thereof—preferably in a proportion of 0.5 wt % to 15 wt %, based upon the total weight of the comb polymer.

The comb polymer is preferably at least partially crosslinked. Crosslinking is to be understood according to the invention as the following types of crosslinking:
1. At least one polymer main chain of the comb polymer is covalently bonded to at least one other polymer main chain of the comb polymer; and/or
2. at least one main polymer chain of the comb polymer is covalently bonded to at least one lateral chain of the comb polymer; and/or
3. at least one lateral chain of the comb polymer is covalently bonded to at least one further lateral chain of the comb polymer; and/or
4. the aforementioned types of crosslinking are in combination.

The crosslinking of the comb polymer can take place via conventional crosslinking methods known to the person skilled in the art, e.g., free-radical and/or ionic crosslinks, polymer-analogous crosslinks, coordinative crosslinks, and/or electrode-beam crosslinking.

The crosslinking of the comb polymer preferably takes place via crosslinking units polymerized into the polymer main chain and/or polymer lateral chain.

The polymerized crosslinking units can be obtained by copolymerizing bifunctional or polyfunctional monomers during production of the comb polymer.

Suitable bifunctional or polyfunctional monomers for free-radical polymerization are, in particular, compounds which can polymerize and/or crosslink at two or more locations in the molecule. Such compounds preferably have two identical or similar reactive functionalities. Alternatively, compounds having at least two, differently reactive functionalities can be used. Preferred bifunctional or polyfunctional monomers include, for example, diacrylates, dimethylacrylates, triacrylates, trimethacrylates, tetraacrylates, tetramethacrylates, pentaacrylates, pentamethacrylates, hexaacrylates, hexamethacrylates, diacrylamides, dimethacrylamides, triacrylamides, trimethacrylamides, tetraacrylamides, tetramethacrylamides, pentaacrylamides, pentamethacrylamides, hexaacrylamides, hexamethacrylamides, divinyl ethers, divinylbenzenes, 3,7-dimethyl-1,6-octadien-3-ol, and/or mixtures thereof.

Particularly preferred are 1,3-butanediol diacrylate, 1,6-hexanediol diacrylate, 1,9 nonanediol diacylate, neopentylglycol diacrylate, 1,6-hexanediol ethoxylate diacrylate, 1,6-hexanediol propoxylate diacrylate, 3-(acryloyloxy)-2-hydroxypropyl methacrylate, 3-hydroxy-2,2-dimethylpropyl 3-hydroxy-2,2-dimethylpropionate diacrylate, 5-ethyl-5-(hydroxymethyl)-β,β-dimethyl-1,3-dioxane-2-ethanol diacrylate, bisphenol-A-ethoxylated diacrylate with a molecular weight of approximately 450 g/mol to 700 g/mol, bisphenol-A-propoxylate diacrylate, di(ethylene glycol)-diacrylate, pentaerythritol-diacrylate monostearate, poly(ethylene glycol)-diacrylate with a molecular weight of approximately 250 g/mol to 2,500 g/mol, poly(ethylene glycol)-dimethacrylate with a molecular weight of approximately 250 g/mol to 2,500 g/mol, tetra(ethylene glycol)-diacrylate, tri(propylene glycol) diacrylate, tri(propylene glycol)-glycerolate-diacrylate, trimethylolpropane-benzoate diacrylate, vinyl crotonate, 1,3-divinylbenzene, 1,4-divinylbenzene, 1,6 bis(3,4-epoxy-4-methylcyclohexanecarboxylic acid) hexyl diester, vinyl acrylate, vinyl methacrylate, di(trimethylolpropane)-tetraacrylate, dipentaerythritol penta-/hexa-acrylate, pentaerythritol propoxylate triacrylate, pentaerythritol tetraacrylate, trimethylolpropane ethoxylate triacrylate with a molecular weight of 400 g/mol to 1,000 g/mol, N,N′-methylenebisacrylamide, poly(ethylene glycol) diacrylamides, tris[2-(acryloyloxy)ethyl]-isocyanurate, 3,7-dimethyl-1,6-octadien-3-ol, and/or mixtures thereof.

In a further preferred embodiment of the invention, the proportion of crosslinking units is 1 wt % to 75 wt %, more preferably 2 wt % to 55 wt %, more preferably 2 wt % to 45 wt %, and in particular 2 wt % to 25 wt %. The proportion of crosslinking units corresponds to the proportion of the bifunctional or polyfunctional monomers, based upon the total quantity of monomers during the production of the comb polymer.

In another preferred embodiment of the invention, the thickness of the membrane according to the invention, measured according to test specification DIN EN ISO 9073-2, is from 10 μm to 4 cm, and/or from 10 μm to 2 cm, and/or from 14 μm to 1 cm, and/or from 14 μm to 500 μm, and/or 14 μm to 300 μm, and/or 14 μm to 200 μm, and/or 14 μm to 150 μm.

For use as a separator for energy converters, preferred thicknesses are from 14 μm to 500 μm, more preferably from 14 μm to 200 μm, and in particular from 14 μm to 150 μm.

For use as separators for energy storage devices, preferred thicknesses are from 10 μm to 500 μm, more preferably from 10 μm to 200 μm, more preferably from 10 μm to 150 μm, more preferably from 10 μm to 100 μm, more preferably from 10 μm to 50 μm, and in particular from 10 μm to 25 μm.

For use as water vapor-permeable membranes for functional textiles and humidification modules, preferred thicknesses are from 14 μm to 500 μm, more preferably from 14 μm to 200 μm, more preferably from 14 μm to 150 μm, more preferably from 14 μm to 85 μm, and in particular from 14 μm to 30 μm.

For use as filter media for gas and liquid filtration, preferred thicknesses are from 25 μm to 4 cm, and/or from 25 μm to 2 cm, and/or 25 μm to 1 cm, and/or from 25 μm to 500 μm, and/or from 25 μm to 300 μm.

In another preferred embodiment of the invention, the weight of the membrane is from 5 g/m² to 500 g/m², more preferably from 8 g/m² to 250 g/m², more preferably from 10 g/m² to 150 g/m², and in particular from 10 g/m² to 100 g/m².

For use as a separator for energy converters, preferred basis weights are from 5 g/m² to 200 g/m², more preferably from 5 g/m² to 150 g/m², more preferably 5 g/m² to 100 g/m², more preferably from 5 g/m² to 50 g/m², and in particular from 5 g/m² to 25 g/m².

For use as separators for energy storage devices, preferred basis weights are from 8 g/m² to 300 g/m², more preferably from 8 g/m² to 200 g/m², more preferably from 8 g/m² to 100 g/m², more preferably from 8 g/m² to 50 g/m², and in particular from 8 g/m² to 25 g/m².

For use as water vapor-permeable membranes for functional textiles and humidification modules, preferred basis weights are from 10 g/m² to 300 g/m², more preferably from 10 g/m² to 200 g/m², more preferably from 10 g/m² to 100 g/m², more preferably from 10 g/m² to 50 g/m², and in particular from 10 g/m² to 25 g/m².

For use as filter media for gas and liquid filtration, preferred basis weights are from 10 g/m² to 500 g/m², more preferably from 10 g/m² to 300 g/m², more preferably from 10 g/m² to 200 g/m², more preferably from 10 g/m² to 150 g/m², and in particular from 10 g/m² to 100 g/m².

In another preferred embodiment, the Lewis-acid and/or Lewis-base functionalities are selected from primary, secondary, tertiary, and quaternary amino groups, imino, enamino, lactam, nitrate, nitrite, carboxyl, carboxylate ketyl, aldehyde, lactone, carbonate, sulfonyl, sulfonate, sulfide, sulfite, sulfate, sulfonamide, thioether, phosphonyl phosphonate, phosphate, phosphoric acid ester, ether, hydroxyl, hydroxide, halide, coordinately-bonded metal ion—in particular, transition metal ion—thiocyanate, and/or cyanide groups.

Particularly preferred are the Lewis-acid and/or Lewis-base functionalities selected from primary, secondary, tertiary, and quaternary amino groups, lactam, lactone, ether, carboxyl, carboxylate, sulfonyl, sulfonate, phosphoric ester, phosphonyl, and/or phosphonate groups.

For use as a separator for energy converters, preferred Lewis-acid and/or Lewis-base functionalities are selected from primary, secondary, tertiary, and quaternary amino groups, lactam, lactone, ether, carboxyl, carboxylate, sulfonyl, sulfonate, phosphoric ester, phosphonyl, and/or phosphonate groups.

For use as separators for energy storage devices, preferred Lewis-acid and/or Lewis-base functionalities are selected from lactam, lactone, ether, carboxyl, carboxylate, sulfonyl, sulfonate, phosphoric ester, phosphonyl, and/or phosphonate groups.

For use as water vapor-permeable membranes for functional textiles and humidification modules, preferred Lewis-acid and/or Lewis-base functionalities are selected from primary, secondary, tertiary, and quaternary amino groups, ether, carboxyl, carboxylate, sulfonyl, sulfonate, phosphoric ester, phosphonyl, and/or phosphonate groups.

In a further preferred embodiment of the invention, the conductivity of the membrane according to the invention in 1 molar LiPF6 in propylene carbonate is less than 200 mOhm*cm²/μm, and particularly preferably 200 mOhm*cm²/μm to 50 mOhm*cm²/μm. Such conductivities have proven particularly effective for separators for energy storage devices—in particular, when organic electrolytes are used. In this embodiment, the membrane preferably has Lewis-acid and/or Lewis-base functionalities selected from lactone, ether, carboxyl, and/or sulfonate groups.

In a further preferred embodiment of the invention, the electrical resistance of the membrane according to the invention in 30% KOH is less than 0.3 Ohm*cm²—particularly preferably between 0.05 Ohm*cm² and 0.2 Ohm*cm². Such conductivities have also proven particularly effective for separators for energy storage devices—in particular, when aqueous electrolytes are used. In this embodiment, the membrane preferably has Lewis-acid and/or Lewis-base functionalities selected from carboxyl, carboxylate, phosphonate, and/or sulfonate groups.

In another preferred embodiment of the invention, the air permeability of the membrane according to the invention, measured according to EN ISO 9237 at 200 Pascals of air flow, is from 0 L/(s*m²) to 400 L/(s*m²), preferably from 0 L/(s*m²) to 200 L(s*m²), more preferably from 0 L/(s*m²) to 100 L/(s*m²), and more preferably from 0 L/(s*m²) to 50 L/(s*m²).

For use as water vapor-permeable membranes for functional textiles and humidification modules, preferred air permeabilities, measured according to EN ISO 9237 at 200 Pascals of air flow, are from 0 L/(s*m²) to 100 L/(s*m²), and more preferably from 0 L/(s*m²) to 50 L/(s*m²).

In another preferred embodiment of the invention, the water vapor permeability of the membrane according to the invention, according to ASTM D1653, is from 1 g/m²*min to 500 g/m²*min, preferably from 4 g/m²*min to 100 g/m²*min, more preferably from 5 g/m²*min to 75 g/m²*min, and more preferably from 5 g/m²*min to 50 g/m²*min. The high water vapor permeabilities achievable with the membrane according to the invention are particularly advantageous for use as a water vapor-permeable membrane for functional textiles and/or humidification modules, since this ensures good water vapor transport.

In a further preferred embodiment of the invention, the membrane according to the invention has an anisotropic water vapor permeability. This means that the water vapor permeability differs depending upon the selected water vapor inlet side (that is, the side in which the water reservoir is located). That side which has a higher level of water vapor passage when used as the water vapor inlet side is defined as the upper side. The anisotropy of the water vapor permeability, determined as the quotient between the water vapor passage when using the upper side as the water vapor inlet side and the water vapor passage when using the lower side as the water vapor inlet side, is preferably 3 to 100, more preferably 5 to 50, and in particular 8 to 25.

In a further preferred embodiment of the invention, the Gurley value of the membrane according to the invention, measured according to ASTM D-726-58 with an air volume of 50 cm³, is at least 200 s, and more preferably at least 750 s. The person skilled in the art knows that he can selectively affect the Gurley value by adjusting certain parameters—for example, by fiber titer, density of the porous substrate, and/or quantity of comb polymer. The setting of a high Gurley value of at least 500 s is advantageous, since, by means of a targeted reduction of the pore size, the passage of particles (for example, electrode particles or degradation products), dendrites, and gases can thus be prevented or at least reduced.

Preferred Gurley values for use as water vapor-permeable membranes for functional textiles and humidification modules are at least 500 s, more preferably at least 800 s, and in particular at least 1,000 s. The setting of a high Gurley value of at least 500 s is advantageous, since the gas passage of oxygen through the membrane can thereby be reduced.

In another preferred embodiment of the invention, the electrolyte absorption of the membrane is from 2 wt % to 600 wt %. More preferably 10 wt % to 400 wt %, more preferably 10 wt % to 250 wt %, and in particular 25 wt % to 150 wt %. Such values are particularly relevant for use as a separator for energy converters and energy storage devices.

In a further preferred embodiment of the invention, the membrane according to the invention has a porosity of from 5% to 85%, more preferably from 15% to 65%, and in particular from 15% to 45%.

For use as a filter medium for gas and liquid filtration, preferred porosities are from 5% to 85%, more preferably from 45% to 85%, and in particular from 65% to 85%.

In a further preferred embodiment of the invention, the membrane according to the invention has a shrinkage in area at 120° C. of 0.1% to 10%, and more preferably of 0.1% to 5%.

The proportion of comb polymer in the membrane according to the invention is preferably 20 wt % to 200 wt %, more preferably 50 wt % to 150 wt %, and in particular 75 wt % to 130 wt %, in each case based upon the weight of the porous substrate.

According to the invention, the membrane has a porous substrate. A “porous substrate” is understood according to the invention to be a fabric which is suitable as a base material for the membrane for selective transport of substances—in particular, in batteries, capacitors, fuel cells, electrolyzers, as a water vapor-permeable membrane for functional textiles and humidification modules, and/or as a filter medium for gas and liquid filtration.

Preferably, the porous substrate has a thickness, measured according to test specification DIN EN ISO 9073-2, of from 8 μm to 500 μm, more preferably from 10 μm to 500 μm, more preferably from 10 μm to 250 μm, and in particular from 10 μm to 200 μm.

For use as a separator for energy converters, preferred thicknesses for the porous substrate are from 8 μm to 250 μm, more preferably from 8 μm to 150 μm, more preferably from 8 μm to 75 μm, and in particular from 8 μm to 50 μm.

For use as water vapor-permeable membranes for functional textiles and humidification modules, preferred thicknesses for the porous substrate are from 8 μm to 350 μm, more preferably from 15 μm to 200 μm, more preferably from 15 μm to 150 μm, and in particular from 15 μm to 100 μm.

Likewise preferably, the porous substrate has a weight, measured according to test specification ISO 9073-1, of 3 g/m² to 300 g/m², more preferably 5 g/m² to 200 g/m², more preferably 5 g/m² to 150 g/m², and in particular 5 g/m² to 100 g/m².

In a further preferred embodiment of the invention, the porous substrate has a porosity of from 25% to 90%, more preferably from 35% to 80%, and in particular from 40% to 75%, prior to application of the comb polymer.

Particularly suitable as porous substrates according to the invention are microporous membranes such as, preferably, polyester membranes—in particular, polyethylene terephthalate and polybutylene terephthalate membranes, polyolefin membranes—in particular, polypropylene or polyethylene membranes, polyimide membranes, polyurethane membranes, polybenzimidazole membranes, polyetheretherketone membranes, polyethersulfone membranes, polytetrafluoroethylene membranes, polyvinylidene fluoride membranes, polyvinyl chloride membranes, and/or laminates thereof.

Particularly preferred microporous membranes are polyolefin membranes, polyester membranes, polybenzimidazole membranes, polyimide membranes, and/or laminates thereof.

In a preferred embodiment, the microporous membranes have an inorganic coating, preferably based upon aluminum oxide, boehmite, silicon dioxide, zirconium phosphate, titanium dioxide, diamond, graphene, expanded graphite, boron nitride, and/or mixtures thereof.

Coatings based upon aluminum oxide, silicon dioxide, titanium dioxide, zirconium phosphate, boron nitride, and/or mixtures thereof are particularly preferred.

In another preferred embodiment of the invention, the porous substrate is selected from textile fabrics—in particular, woven fabrics, knitted fabrics, papers, and/or nonwovens. It is advantageous with textile fabrics that they have a low degree of thermal shrinkage and a high degree of mechanical stability. This is advantageous for use in batteries, capacitors, fuel cells, electrolyzers, and/or combinations thereof, since this increases the safety of the same.

Nonwovens are particularly preferred, because they combine a high degree of isotropy of their physical properties with a favorable production.

Nonwovens can be spunbond nonwovens, meltblown nonwovens, wet nonwovens, dry nonwovens, nanofiber nonwovens, and nonwovens spun from solution. In one embodiment, spunbond nonwovens are preferred, because they can be provided with a high degree of mechanical strength through the targeted adjustment of the distribution of the fiber thicknesses. In a further embodiment, meltblown nonwovens are preferred, because they can be provided with a low degree of fiber thickness and a highly homogeneous distribution with respect to the fiber thicknesses. In a further embodiment, dry nonwovens are preferred, because they have a high degree of tensile strength of the fibers. In a particularly preferred embodiment, the textile fabric is a wet nonwoven, because it can be produced with a highly uniform fiber distribution, a low weight, and an especially low thickness. A low thickness of the porous nonwoven substrate enables electrochemical energy storage devices and converters with a high degree of energy density and power density.

The nonwoven—in particular, in its embodiment as a wet nonwoven—can have staple fibers and/or short-cut fibers. According to the invention, in contrast to filaments that have a theoretically unlimited length, “staple fibers” are understood to be fibers that have a limited length—preferably of 1 mm to 80 mm, and more preferably of 3 mm to 30 mm. According to the invention, short-cut fibers are to be understood as meaning fibers with a length of preferably 1 mm to 12 mm, and more preferably 3 mm to 6 mm. The mean titer of the fibers can vary depending upon the desired structure of the nonwoven. The use of fibers having a mean titer of 0.06 dtex to 3.3 dtex, preferably of 0.06 dtex to 1.7 dtex, and preferably of 0.06 dtex to 1.0 dtex, has, in particular, proved to be favorable.

Practical tests have shown that the at least partial use of microfibers having a mean titer of less than 1 dtex—preferably of 0.06 dtex to 1 dtex—has an advantageous effect on the size and structure of the pore sizes and inner surface, and also on the thickness of the nonwoven. In this, proportions of at least 5 wt %, preferably of 5 wt % to 35 wt %, and particularly preferably of 5 wt % to 20 wt % of microfibers, in each case based upon the total quantity of fibers in the nonwoven, have proved to be particularly favorable. Thus, it was found in practical tests that a particularly homogeneous coating can be achieved with the aforementioned parameters.

The fibers can be formed in a wide variety of shapes, e.g., flat, hollow, round, oval, trilobal, multilobal, bico, and/or island-in-the-sea fibers. According to the invention, the cross-section of the fibers is preferably round.

According to the invention, the fibers can contain a wide variety of fiber polymers—preferably polyacrylonitrile, polyvinyl alcohol, viscose, cellulose, polyamides—in particular polyamide 6 and polyamide 6.6, polyesters—in particular polyethylene terephthalate and/or polybutylene terephthalate, copolyesters, polyolefins—in particular polyethylene and/or polypropylene, and/or mixtures thereof. Polyesters—in particular, polyethylene terephthalate and/or polybutylene terephthalate and/or polyolefins—in particular, polyethylene and/or polypropylene—are preferred.

The use of polyesters has the advantage that they have a high degree of mechanical strength. The advantage of using polyolefins is that, because of their hydrophobic surface, they do not restrict the mobility of hydrophilic lateral chains.

Advantageously, the fibers contain the aforementioned materials in a proportion of more than 50 wt %, preferably more than 90 wt %, and more preferably from 95 to 100 wt %. Very particularly preferably, they consist of the aforementioned materials, wherein it is possible for the usual impurities and auxiliary agents to be present.

The fibers of the nonwoven may be in the form of matrix fibers and/or binding fibers. Binding fibers, within the meaning of the invention, are fibers which, during the production process of the nonwoven for example, can form solidification points and/or solidification regions at least at some intersection points of the fibers as a result of heating to a temperature above their melting point and/or softening point. At these intersection points, the binding fibers can form firmly-bonded connections to other fibers and/or to themselves. The use of binding fibers thus makes it possible to construct a framework and to obtain a thermally-solidified nonwoven. Alternatively, the binding fibers can also melt completely and solidify the nonwoven in this way. The binding fibers can be formed as core-sheath fibers, in which the sheath constitutes the binding component, and/or as non-drawn fibers.

Matrix fibers, within the meaning of the invention, are fibers which, unlike binding fibers, are present in a significantly clearer fiber form. An advantage of the presence of the matrix fibers is that the stability of the fabric as a whole can be increased.

The membrane according to the invention for selective transport of substances can be produced in a simple manner by a method comprising the following steps:
providing a porous substrate
providing a reaction mixture comprising a polymerization initiator along with
   a) a polymerizable monomer having a Lewis-acid and/or Lewis-base functionality and a bi- or polyfunctional monomer, and/or
   b) a polymerizable macromonomer having a Lewis-acid and/or Lewis-base functionality
impregnating and/or coating the porous substrate with the reaction mixture
polymerization of the monomers and/or macromonomers to form a comb polymer, which contains a main polymer chain along with several lateral chains covalently bonded to the main polymer chain, and wherein at least one of the lateral chains has at least one Lewis-acid and/or Lewis-base functionality.

In variant a, the reaction mixture comprises a bi- or polyfunctional monomer. This can lead to crosslinking of the comb polymer formed during the polymerization.

In variant b, a bi- or polyfunctional monomer can likewise be present in the reaction mixture, for crosslinking the comb polymer. However, the macromonomer itself could also have crosslinkable units.

In a preferred embodiment of the invention, the polymerization of the monomers and/or macromonomers and the crosslinking of the comb polymer take place simultaneously.

The crosslinking of the comb polymer can take place via crosslinking units polymerized into the main polymer chain and/or polymer lateral chain, wherein the polymerized crosslinking units can be obtained by copolymerizing bifunctional or polyfunctional monomers during production of the comb polymer.

The preferred types of crosslinking are those described above. Free-radical crosslinks are particularly preferred.

The polymerization of the monomers and/or macromonomers to form the comb polymer preferably takes place in a free-radical and/or ionical manner. Thereby, the polymerization can preferably be initiated thermally and/or in a radiation-induced manner.

A further subject matter of the present invention relates to the use of the membrane according to the invention for the selective transport of substances—in particular, as an ion-selective membrane for energy converters, in particular for separating the electrochemical half-cells in fuel cells and/or electrolyzers; as a separator for separating the electrochemical half-cells in energy storage devices, such as, in particular, capacitors along with primary or secondary batteries; as a water vapor-permeable membrane for functional textiles and/or humidification modules—preferably for humidifiers, in particular for humidifiers in fuel cells; and/or as a filter medium for gas and/or liquid filtration.

Another subject matter of the present invention relates to an electrochemical energy storage device and/or converter—preferably batteries—in particular, primary or secondary batteries, capacitors, fuel cells, electrolyzers, and/or combinations thereof—comprising a membrane according to the invention.

Another subject matter of the present invention relates to a functional textile and/or a humidification module—preferably a humidifier—in particular, a humidifier for fuel cells—comprising the membrane according to the invention.

### Measuring Methods:

### Basis Weight:

The basis weight of the membrane according to the invention was determined according to test specification ISO 9073-1.

Thickness:

The thickness of the membrane according to the invention was measured according to test specification DIN EN ISO 9073-2. The measuring surface is 2 cm²; the measuring pressure is 1,000 cN/cm².

### Gurley Measurements:

Based upon ASTM D-726-58, the Gurley values of the membrane are determined. The test determines the time required for a particular volume of air (50 cm³) to pass through a standard surface of a material under a slight pressure. The air pressure is given by an inner cylinder with a specific diameter and a standardized weight, free-floating in an outer cylinder, partially filled with an oil acting as an air seal. If a determination of the air permeability of the membrane according to Gurley is not possible, this means that the membrane is so thick that no air permeability can be measured.

### Porosity:

In the context of this description, this is to be understood by the following expression: P=(1−FG/(d·& δ))·100, where FG is the basis weight of the porous substrate in kg/m², d is the thickness in m, and δ is the density in kg/m³.

### Ionic Resistance:

The ionic resistance of the membrane according to the invention is determined by impedance spectroscopy.

In organic electrolytes: For this purpose, the samples to be examined are dried at 120° C. in a vacuum and then placed in 1M LiPF6 in propylene carbonate for 5 hours, such that they are completely wetted with electrolyte. These samples are subsequently placed between 2 polished stainless steel punches, and the impedance is measured from 1 Hz to 100 kHz.

In aqueous electrolytes: For this purpose, the samples to be examined are placed in the aqueous electrolytes (30% KOH for examples in Table 2; 10% sulfuric acid for examples in Table 3) for 5 hours, such that they are completely wetted with electrolyte. These samples are subsequently placed between two polished stainless steel punches, and the impedance is measured from 1 Hz to 100 kHz.

### Electrolyte Absorption:

Electrolyte absorption is determined in accordance with EN 29073-03. In organic electrolytes, LiPF6 is used in propylene carbonate (1 molar); in aqueous electrolytes, 30% KOH.

### Sulfide Shuttle:

A polysulfide solution is prepared by dissolving stoichiometric quantities of Li2S, and elemental sulfur in DOL/DME (50:50 (vol %)) at 60° C. is prepared while stirring. In order to determine the sulfide impermeability of the membrane, two half-cells of glass are separated by a membrane. Pure, transparent DOL/DME (50:50 (vol %)) is added to one cell, and 0.5 M red-brown polysulfide solution in DOL/DME (50:50 (vol %)) is added to the other half-cell. The extent of sulfide permeation through the membrane at 23° C. is determined by the color change of the transparent DOL/DME (50:50 (vol %)) after 1 hour, 2 hours, 24 hours, and 48 hours.

### Air Permeability Measurements:

The air permeabilities are determined on the basis of DIN EN ISO 9237; the test result is indicated in dm³/s*m².

### Determination of Water Vapor Transfer Rate:

The water vapor transfer rate is determined based upon ASTM D1653. The measurements are taken in an airtight box (height: 29.8 cm, width 20.8 cm, depth 15.8 cm). The measuring temperature in the box is 21° C., the air speed is 3.8 m/s, and the total air flow through the box is 19.25 m³/h. The water permeability of the membranes is determined by means of an Elcometer 5100/1; the measuring surface of the membrane has a diameter of 3.56 cm. The water vapor transport through the membrane is determined in g/m²*min.

### Shrinkage of the Surface:

For the determination of the shrinkage, samples of 100 mm×100 mm are punched out and stored for one hour at 120° C. in a lab dryer made by Mathis. The shrinkage of the samples is then determined.

### Example 1

A PET wet nonwoven (basis weight: 40 g/m²; thickness 0.1 mm) was coated with a solution consisting of 70 g of a PEG-functionalized dimethacrylate (Mn PEG: 308 g/mol), 8 g of a PEG-diacrylate (Mn PEG: 250 g/mol), 170 g of water, and 2.5 g of a commercially available UV radical initiator and irradiated with UV light for 60 seconds. The resulting coated nonwoven was then washed in a water bath and dried at 100° C. The test was repeated 4 times, and the average values of the thicknesses and the weights were determined. A coated nonwoven with a thickness of 0.145 mm and a basis weight of 101.5 g/m² was obtained.

### Example 2

A PP wet nonwoven (basis weight: 50 g/m²; thickness 0.1 mm) was coated with a solution consisting of 67.5 g of a PEG-functionalized acrylate (Mn PEG: 480 g/mol), 10 g of a PEG-diacrylate (Mn PEG: 250 g/mol), 166.3 g of water, and 5.1 g of a commercially available UV radical initiator and irradiated with UV light for 60 seconds. The resulting coated nonwoven was then washed in a water bath and dried at 100° C. The test was repeated 4 times, and the average values of the thicknesses and weights were determined. A coated nonwoven with a thickness of 0.11 mm and a basis weight of 89.2 g/m² was obtained.

### Example 3

A PP wet nonwoven (basis weight: 50.2 g/m²; thickness 0.103 mm) was coated with a solution consisting of 135 g of a PEG-functionalized acrylate (Mn PEG: 480 g/mol), 25 g of a PEG-diacrylate (Mn PEG: 250 g/mol), 320 g of water, and 5 g of a commercially available UV radical initiator and irradiated with UV light for 60 seconds. The resulting coated nonwoven was then washed in a water bath and dried at 100° C. A coated nonwoven with a thickness of 0.117 mm and a basis weight of 87.4 g/m² was obtained.

### Comparative Example 1 (Coated with Linear Polymers)

A PET wet nonwoven (weight 85 g/m², thickness 0.12 mm) is coated with a 50% aqueous dispersion of a polyurethane acrylate and dried at 120° C. The polyurethane acrylate is not a comb polymer, which has at least one lateral chain with a molecular weight of at least 60 g/mol and/or at least 5 repeat units. Rather, the lateral chains preferably have a molecular weight of 500 to 1,000 g/mol. During drying, thermal crosslinking of the polyurethane acrylate occurs. A coated nonwoven with a thickness of 0.128 mm and a weight of 145 g/m² was obtained.

Examples 1-3 do not have air permeability according to Gurley. This means that no continuous pores are present. The electrical resistance of the membrane, measured in 1 M LiPF6 dissolved in propylene carbonate, is very low and of the same order of magnitude as in commercial membranes. There is no dependence of the electrical conductivity on the pore sizes of the continuous pores. A diffusion of sulfide ions through the membrane (in DOL/DME) could not be detected.

TABLE 1
MEMBRANES FOR ORGANIC ELECTROLYTES.

| | | | | | | Electrical | Sulfide |
|---|---|---|---|---|---|---|---|
| | Weight, | Thickness, | Weight, | Thickness, | | resistance at | shuttle |
| | uncoated | uncoated | coated | coated | Gurley 50 | 100 kHz | suppression |
| | [g/m²] | [μm] | [g/m²] | [μm] | cm³ [s] | [mOhm*cm²/μm] | (DOL/DME) |
| Example 1 | 40 | 100 | 102 | 145 | Not | 65 | Yes |
| (V1) | | | | | measurable/ | | |
| | | | | | airtight | | |
| Example 2 | 50 | 100 | 89 | 110 | Not | 120 | Yes |
| (V2) | | | | | measurable/ | | |
| | | | | | airtight | | |
| Example 3 | 50 | 100 | 87 | 117 | Not | 110 | Yes |
| (V3) | | | | | measurable/ | | |
| | | | | | airtight | | |
| Comparative | 85 | 120 | 145 | 128 | 850 | 810 | No |
| example 1 | | | | | | | |
| Uncoated | 40 | 110 | — | — | 0 | 60 | No |
| nonwoven | | | | | | | |
| 3-layer PO | 13 | 25 | — | — | 610 | 90 | No |
| membrane | | | | | | | |
| 3-layer PO | 11 | 20 | — | — | 520 | 100 | No |
| membrane | | | | | | | |
| AI₂O₃ coated | 7 | 17 | 30 | 25 | 95.4 | 120 | No |
| PET nonwoven | | | | | | | |
| + | | | | | | | |
| AI₂O₃ coated | — | — | 22 | 20 | 450 | 110 | No |
| PE membrane | | | | | | | |

### Example 4-8

PP wet nonwovens (see Table 2) were coated with a solution consisting of 62.5 g acrylic acid, 6 g of a crosslinker, 125.5 g of water, and 2 g of a commercially available UV radical initiator and continuously irradiated with UV light. The application rate was varied by means of the speed of the applicator roller. The resulting coated nonwovens were then washed in a water bath and dried at 100° C. Coated nonwovens with weights of 77 g/m² to 110 g/m² were obtained (see Table 2).

With these examples, the electrical resistance in 30% KOH of the membrane can be adjusted independently of the air permeability, i.e., independently of the pore sizes of the continuous pores. Thus, the electrical conductivity is decoupled from the pore size.

TABLE 2
MEMBRANES FOR AQUEOUS ALKALINE ELECTROLYTES.

| | | | | | | | Electrical |
|---|---|---|---|---|---|---|---|
| | Weight, | Thickness, | Weight, | Thickness, | Airflow | KOH | resistance at |
| | uncoated | uncoated | coated | coated | (200 Pa) | absorption | 100 kHz |
| | [g/m²] | [μm] | [g/m²] | [μm] | [L/(s*m²)] | [%] | [Ωcm²] |
| Example 4 | 50 | 120 | 77 | 125 | 0.02 | 347 | 0.101 |
| (V4) | | | | | | | |
| Example 5 | 67 | 220 | 96 | 228 | 183 | 256 | 0.143 |
| (V5) | | | | | | | |
| Example 6 | 67 | 220 | 82 | 220 | 280 | 267 | 0.119 |
| (V6) | | | | | | | |
| Example 7 | 67 | 220 | 110 | 225 | 52 | 252 | 0.176 |
| (V7) | | | | | | | |
| Example 8 | 67 | 220 | 109 | 232 | 0.06 | 321 | 0.180 |
| (V8) | | | | | | | |
| 3-layer | — | — | 141 | 255 | 0.02 | 216 | 0.330 |
| laminate | | | | | | | |
| (nonwoven- | | | | | | | |
| membrane- | | | | | | | |
| nonwoven) | | | | | | | |

### Example 9

A PP wet nonwoven (basis weight: 50.2 g/m²; thickness 0.12 mm) was coated with a solution consisting of 12.5 kg of acrylic acid, 600 g of a crosslinker, 6.3 kg of water, and 200 g of a commercially available UV radical initiator and continuously irradiated with UV light. The resulting coated nonwoven was then washed in a water bath and dried at 100° C. A coated nonwoven with a thickness of 0.125 mm and a basis weight of 77 g/m² was obtained.

In Example 8, the electrical resistance, measured in 10% H2504, is less than that of the commercially available Nafion membrane (see Table 3).

In Example 9, the electrical conductivity, measured in 10% H2504, is greater than the commercially available perfluorosulfonic acid membrane (PFSA; see Table 3). Air permeability according to Gurley could not be measured due to the complete air impermeability. There is no correlation between the electrical conductivity and the maximum pore size of the membrane.

TABLE 3
MEMBRANES FOR AQUEOUS ACIDIC ELECTROLYTES.

| | | | | | | | Electrical |
|---|---|---|---|---|---|---|---|
| | Weight, | Thickness, | Weight, | Thickness, | Airflow | Conductivity | resistance at |
| | uncoated | uncoated | coated | coated | (200 Pa) | at 100 kHz | 100 kHz |
| | [g/m²] | [μm] | [g/m²] | [μm] | [L/(s*m²)] | [mS/cm] | [Ωcm²] |
| Example 8 | 67 | 220 | 109 | 232 | 0.06 | | 0.384 |
| (V8) | | | | | | | |
| Example 9 | 50 | 120 | 77 | 125 | 0 | 86 | |
| (V9) | | | | | | | |
| PFSA | — | — | 107 | 50 | 0 | 59 | |
| membrane | | | | | | | |
| Nation | 360 | 183 | | | 0 | | 0.608 |
| NM-117 | | | | | | | |

### Example 10

A PP nonwoven (basis weight: 80 g/m²; thickness 250 μm) was coated with a solution consisting of 10.9 wt % of NaOH, 28 wt % of acrylic acid, 0.5 wt % of a diacrylamide crosslinker, 20.2 wt % of water, 2 wt % of a nonionic surfactant, and 1 wt % of a commercially available UV radical initiator and continuously irradiated with UV light. The resulting coated nonwoven was then washed in a water bath and dried at 100° C. Coated nonwoven with a thickness of 094 μm and a basis weight of 157 g/m² was obtained.

### Example 11

A PP wet nonwoven (basis weight: 37 g/m²; thickness 80 μm) was coated with a solution consisting of 39.6 wt % of acrylic acid, 2.8 wt % of a diacrylamide crosslinker, 57 wt % of water, and 0.6 wt % of a commercially available UV radical initiator and continuously irradiated with UV light. The resulting coated nonwoven was then washed in a water bath and dried at 100° C. A coated nonwoven with a thickness of 112 μm and a basis weight of 62.3 g/m² was obtained. The water vapor permeability was determined in both directions (measurement of side A→B, measurement of side B→A). The material has a water vapor permeability that varies by approximately a factor of 10, depending upon the test direction.

TABLE 4
TRANSPORT MEMBRANES FOR WATER VAPOR TRANSPORT

| | | | | | | Water | Air |
|---|---|---|---|---|---|---|---|
| | Weight, | Thickness, | Weight, | Thickness, | Bubble | vapor | permeability |
| | uncoated | uncoated | coated | coated | point | permeability | (200 Pa) |
| | [g/m²] | [μm] | [g/m²] | [μm] | [μm] | [g/m²*min] | [L/s*m²]] dry |
| Example 10 | 80 | 250 | 157 | 688 | 4.9 | 15.49 | <1 |
| (43-08 Sol 4) | | | | | | | |
| Example 11 | 37 | 80 | 62.3 | 112 | <1 | 17.61 | <1 |
| A→B | | | | | | | |
| Example 11 | 37 | 80 | 62.3 | 12 | <1 | 1.61 | <1 |
| B→A | | | | | | | |
| Nonwoven | 37 | 80 | — | — | 31.5 | 3.8 | >100 |
| uncoated | | | | | | | |

Table 4 shows in Example 11 that, by coating the porous substrate with the comb polymer, the water vapor permeability decreases in one direction (passage of water from lower side→upper side), while being more than quadrupled in the other direction.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. A membrane for selective transport of substances, comprising:
a porous substrate with a comb polymer,
wherein the comb polymer contains a polymer main chain and several lateral chains covalently bonded to the polymer main chain,
wherein at least one of the several lateral chains has at least one Lewis-acid and/or Lewis-base functionality.

2. The membrane according to claim 1, wherein an ion conductivity and/or a water vapor permeability of the membrane is decoupled from its air permeability.

3. The membrane according to claim 1, wherein the comb polymer has 10 to 3,000 lateral chains.

4. The membrane according to claim 1, wherein the polymer main chain has polymerized monomers, and
wherein the monomers are selected from a group consisting of acrylates, methacrylates, acrylic acids, methacrylic acids, acrylamides, methacrylamides, vinylamides, vinylpyridines, N-vinylimidazoles, N-vinyl-2-methylimidazoles, vinyl halides, styrenes, 2-methylstyrenes, 4-methylstyrenes, 2-(n-butyl)styrenes, 4-(n-butyl)styrenes, 4-(n-decyl)styrenes, N,N-diallylamines, N,N-diallyl-N-alkylamines, vinyl- and allyl-substituted nitrogen heterocycles, vinyl ethers, vinylsulfonic acids, allylsulfonic acids, vinylphosphonic acids, styrene sulfonic acids, acrylonitriles and methacrylnitriles, and/or mixtures thereof.

5. The membrane according to claim 1, wherein the lateral chain has polymerized monomers selected from a group consisting of acrylates, methacrylates, acrylamides, methacrylamides, vinylamides, vinylpyridines, N-vinylimidazoles, N-vinyl-2-methylimidazoles, vinyl halides, styrenes, 2-methylstyrenes, 4-methylstyrenes, 2-(n-butyl)styrenes, 4-(n-butyl)styrenes, 4-(n-decyl)styrenes, N,N-diallylamines, N,N-diallyl-N-alkylamines, vinyl and allyl-substituted nitrogen heterocycles, vinyl ethers, acrylonitriles and methacrylonitriles, acrylic acids, methacrylic acids, vinylsulfonic acids, allylsulfonic acids, vinylphosphonic acids, styrene sulfonic acids, and/or mixtures thereof.

6. The membrane according to claim 1, wherein at least one lateral chain comprises polymerized macromonomers.

7. The membrane according to claim 1, wherein the comb polymer is at least partially crosslinked.

8. The membrane according to claim 1, wherein the bifunctional or polyfunctional monomers are selected from a group consisting of diacrylates, dimethyl acrylates, triacrylates, trimethacrylates, tetraacrylates, tetramethacrylates, pentaacrylates, pentamethacrylates, hexaacrylates, hexamethacrylates, diacrylamides, dimethacrylamides, triacrylamides, trimethacrylamides, tetraacrylamides, tetramethacrylamides, pentaacrylamides, pentamethacrylamides, hexaacrylamides, hexamethacrylamides, divinyl ethers, divinyl benzenes, 3,7-dimethyl-1,6-octadien-3-ol, and/or mixtures thereof.

9. The membrane according to claim 1, wherein a proportion of comb polymer in the membrane is 20 wt % to 200 wt %.

10. The membrane according to claim 1, wherein the porous substrate is selected from a group consisting of microporous membranes, and/or textile fabrics comprising woven fabrics, knitted fabrics, papers, and/or nonwoven fabrics.

11. The membrane according to claim 1, wherein the membrane has a thickness of 10 μm to 4 cm and/or a weight of 5 g/m² to 500 g/m².

12. The membrane according to claim 1, wherein the Lewis-acid and/or Lewis-base functionalities are selected from a group consisting of primary, secondary, tertiary, and quaternary amino groups, imino, enamino, lactam, nitrate, nitrite, carboxyl, carboxylate ketyl, aldehyde, lactone, carbonate, sulfonyl, sulfonate, sulfide, sulfite, sulfate, sulfonamide, thioether, phosphonyl, phosphonate, phosphate, phosphoric acid ester, ether, hydroxyl, hydroxide, halide, coordinately-bonded transition metal ion thiocyanate, and/or cyanide groups.

13. A method for producing the membrane according to claim 1, the method comprising the following steps:
providing a porous substrate;
providing a reaction mixture comprising a polymerization initiator along with:
a) a polymerizable monomer having a Lewis-acid and/or Lewis-base functionality and a bi- or polyfunctional monomer, and/or
b) a polymerizable macromonomer having a Lewis-acid and/or Lewis-base functionality;
impregnating and/or coating the porous substrate with the reaction mixture; and
polymerizing the monomers and/or macromonomers to form the comb polymer, which contains the main polymer chain along with the several lateral chains covalently bonded to the main polymer chain,
wherein at least one of the several lateral chains has at least one Lewis-acid and/or Lewis-base functionality.

14. A method, comprising:
using the membrane according to claim 1 for the selective transport of substances, including as:
an ion-selective membrane for energy converters for separating electrochemical half-cells in fuel cells and/or electrolyzers;
a separator for separating electrochemical half-cells in energy storage devices comprising capacitors and primary or secondary batteries;
a water vapor-permeable membrane for functional textiles and/or humidification modules comprising humidifiers in fuel cells; and/or
a filter medium for gas and/or liquid filtration.

15. A functional textile and/or humidification module, comprising:
the membrane according to claim 1.

16. The membrane according to claim 3, wherein the lateral chains have a molecular weight of 220 g/mol to 5,000 g/mol.

17. The functional textile and/or humidification module according to claim 15, wherein the functional textile and/or humidification module comprises a humidifier.

18. The functional textile and/or humidification module according to claim 17, wherein the humidifier comprises a humidifier for fuel cells.
